(19) United States
(12) Patent Application Publication
(10) Pub. No.: US 2006/0193386 A1
(43) Pub. Date: Aug. 31, 2006

(54) Method for fast mode decision of variable block size coding

(76) Inventors: Chia-Wen Lin, Chiayi City (TW); Yu-Yuan Tseng, Pingtong (TW); Fan-Di Jou, Taoyuan City (TW)

Correspondence Address: AKIN GUMP STRAUSS HAUER & FELD L.L.P., ONE COMMERCE SQUARE, 2005 MARKET STREET, SUITE 2200, PHILADELPHIA, PA, 19103, US

(21) Appl. No.: 11/065,072

(22) Filed: Feb. 25, 2005

(51) Int. Cl. H04N 11/02; H04N 11/04; H04N 7/12; H04B 1/66

(52) U.S. Cl. 375/240.16; 375/240.24; 375/240.12

(57) ABSTRACT

Methods for fast mode decision of variable size block coding referring to spatial and temporal correlations between a current encoding motion block and at least one reference motion block to decide a best mode for encoding the current encoding motion block. The at least one reference motion block includes at least one neighboring motion block of the current motion block and/or a previous motion block that is located in a previous image frame at a position corresponding to that of the current encoding motion block in a current image frame. At least one block size mode is obtained from the at least one reference motion block. The methods further check the reliability of the at least one block size mode before using the at least one block size to encode the current motion block.

### BACKGROUND

1. Field of the Invention

The present invention relates generally to a method for variable-size block coding and more particularly, to a method for rapidly deciding a best mode used for encoding variable-size blocks of video image data.

2. Background of the Invention

To transmit multi-media data, especially dynamic video data, through a communications network, it is necessary to compress the data to meet available network bandwidth before transmission. Compression techniques, such as MPEG-2, MPEG-4 and H.263, are currently used to compress the video data. The recent-developed H.264 compression technique further enhances the quality of compressed data. In comparison with the prior compression techniques, to obtain a same compression quality, the H.264 technique can save bandwidth. The amount of calculation needed in the H.264 technique, however, is much higher than that necessary in the prior compression techniques.

The H. 264 rules are determined by the ITU-T Video Coding Experts Group and the ISO MPEG Committee. The H.264 technique includes seven block modes used for inter-coding and two block modes for intra-coding. The two block modes for intra-coding includes Intra 16×16 mode and Intra 4×4 mode. There are 8 prediction directions for each block so that a most appropriate block mode can be chosen for coding according to the characteristic of the block to enhance the compression efficiency. Further, for motion prediction, the H.264 technique provides multiple reference frames. A reference frame most similar to a current frame is chosen from the multiple reference frames for prediction. In this manner, the coding efficiency is increased and the accuracy of the motion vector prediction can be up to ¼ pixel.

Although the H.264 technique largely improves coding efficiency, it requires a significant number of calculations, and thus is more complicated. Indeed, the complication of the calculations makes implementing the technique a challenge in the real-time transmission applications. Therefore, it would be desirable to simplify the calculations of the encoders so that the H.264 technique can be more readily used in real-time transmission.

### BRIEF SUMMARY OF THE INVENTION

An object of the present invention is to provide a method for fast mode decision of variable block size coding that saves about half of conventional encoding time without sacrificing significant encoding quality.

In accordance with one preferred embodiment of the present invention, a method for fast mode decision of variable block size coding comprises obtaining at least one reference block size mode from at least one reference motion block, performing a motion estimation for the at least one reference block size mode, and determining a best mode from the at least one reference block size mode motion based on the motion estimation results for used in encoding a current motion block.

In accordance with a second preferred embodiment, a method for fast mode decision of variable block size coding comprises obtaining a plurality of reference modes according to a plurality of reference motion blocks, performing a motion estimation for each of the plurality of reference mode, and determining whether each of the reference block size mode is reliable according to the motion estimation result.

The preferred embodiment of the present invention further comprises determining whether a reference mode of a reference motion block is reliable. The method first determines whether the reference mode has a largest size of block. If the reference mode has a largest size of block, the method determines whether a motion vector magnitude difference of the reference motion block from a current motion block is less than a first threshold, and determines the reference mode is reliable if the motion vector magnitude difference is less than the first threshold. If the reference mode does not have a largest size of block, the method calculates a motion vector variant of the reference motion block that adopts the reference mode, determines whether the motion vector variant of the reference motion block is larger than a second threshold, and determines the reference mode is reliable if the motion vector variant is larger than the second threshold.

In accordance with a third preferred embodiment of the present invention, a method for fast mode decision of variable block size coding comprises obtaining a plurality of reference modes according to a plurality of reference motion blocks, determining that more than half of the plurality of the reference motion blocks adopt a first reference mode, perform a reliability check for the first reference mode, and if the first reference mode is reliable, using the first reference mode to encode a current motion block.

Furthermore, when determining that not more than half of the plurality of the reference motion blocks adopt a same first reference mode, the method performs a motion estimation for all the reference mode of the plurality of the reference motion blocks, checks whether the reference modes are reliable, updates the number of reliable reference modes, determines more than half of the reference modes are reliable, and chooses one reliable reference mode that has a minimal cost to encode the current motion block.

### BRIEF DESCRIPTION OF THE DRAWINGS

FIGS. 1A and 1B illustrate a temporal reference motion block and five spatial reference motion blocks that the current motion block is referred to, respectively, in accordance with an exemplary embodiment of the present invention.

FIGS. 2A and 2B illustrate reference motion blocks having a large motion vector variance and a small motion vector variance, respectively.

FIG. 3 illustrates a process for determining the reliability of reference block size modes in accordance with an exemplary embodiment of the present invention.

FIG. 4 illustrates a process for fast mode decision of variable size block coding in accordance with an exemplary embodiment of the present invention.

### DETAILED DESCRIPTION OF THE INVENTION

To determine a block size mode used for variable-size block coding, two methods are generally used: a top-down splitting method and a bottom-up merging method. Both of the methods need to select one initial block size mode for motion prediction. For the top-down splitting method, a smallest block size mode is chosen among available block size modes as the initial block size mode for performing the motion estimation. Conversely, for the bottom-up merging method, a largest block size mode is chosen as the initial block size mode. The methods then decide whether the initial block size mode satisfies predetermined conditions according to the motion prediction result. If so, the methods use the initial block size mode for encoding. Otherwise, the methods choose other block size modes for motion predictions and decide a best block size mode from the motion prediction results. In general, with higher bit rates, there is a better chance to use a smaller block size mode for encoding, that is, to use the bottom-up merging method. With lower bit rates, however, there is a better chance to use the top-down splitting method.

Other methods are also used to decide the best block size mode for encoding. For example, in one method, a middle-size block mode is initially used for motion prediction. According to the result, it is then decided whether the middle-size block mode should be merged with other block size modes or split into smaller block size modes.

Another method decides a motion vector of a 4×4 block size mode and uses the motion vector to predict an appropriate block size mode for encoding the entire motion block. This method analyzes the probability of the motion vectors to choose an appropriate block size mode rather than performing motion predictions for various block size modes and then choosing one appropriate block size mode for encoding.

A further method predicts the correlation between various sub-block size modes within a motion block. This method first uses an 8×8 sub-block size mode for motion prediction to obtain four sets of motion vectors. The four sets of motion vectors are then used to predict motion vectors of other block size modes. The method then only performs the motion prediction for those block size modes that have significant different motion vectors from the four sets of motion vectors.

The above methods, however, do not consider outside information between a current motion block and its neighboring motion blocks, but only the sub-blocks within the current motion block. In accordance with a preferred embodiment of the present invention, a fast mode decision (FMD) algorithm determines a best block size mode for motion prediction by referring to spatial correlations of a current motion block and its neighboring motion blocks and temporal correlations of the current motion block and a reference motion block of a previous image frame that is located at a position corresponding to that of the current motion block in a current image frame.

Table 1 shows experimental data of the spatial correlations of a current motion block and its neighboring motion blocks in different encoders, such as FOREMAN, COASTGUARD, CARPHONE, CONTAINER, and AKIYO. As shown in Table 1, it is highly possible that a neighboring motion block uses a same block size mode as the current motion block for encoding.

TABLE 1

| | SPATIAL (2) | SPATIAL (3) | SPATIAL (4) |
|---|---|---|---|
| FOREMAN | 50.00% | 56.77% | 63.58% |
| COASTGUARD | 54.17% | 60.21% | 65.17% |
| CARPHONE | 51.90% | 59.08% | 66.14% |
| CONTAINER | 79.46% | 81.76% | 84.43% |
| AKIYO | 86.58% | 88.43% | 90.69% |

Table 1 shows the probabilities in different encoders that a current motion block uses a same block size mode as that of its neighboring motion block for motion predictions. SPATIAL (2) represents the probabilities that a current motion block refers to its left and upper neighboring motion blocks (here, the left and upper neighboring motion blocks are referred as reference motion blocks) and uses a block size mode of either one of the reference motion blocks to perform motion predictions.

Similarly, SPATIAL (3) and SPATIAL (4) represent the probabilities that a current motion block uses one block size mode of any of its reference motion blocks to perform motion predictions, respectively. In SPATIAL (3), the reference motion blocks include left, an upper and an upper left neighboring motion blocks of the current motion block, and in SPATIAL (4), the reference motion blocks further include an upper right neighboring motion block of the current motion block. According to Table 1, there is about 60% probability for the current motion block to accurately predict its block size mode for encoding by referring to the block size modes of its neighboring motion blocks.

In addition to the spatial information, the present invention also considers temporal correlations between neighboring image frames. In video images, a current image frame is usually very similar to its adjacent image frames. Therefore, the motion blocks in two adjacent image frames that encompass static or low-motion object or even backgrounds should be very similar, and thus can use the same block size mode for encoding. That is, a motion block in a current image frame may use the block size mode of a motion block in the previous image frame that is located at a position corresponding to that of the current motion block in the current image frame as a predicted block size mode.

Table 2 shows experimental results of temporal probabilities that a motion block in a current image frame uses the block size mode of a reference motion block in a previous image frame that is located at a position corresponding to that of the current motion block.

TABLE 2

| | TEMPORAL |
|---|---|
| FOREMAN | 43.70% |
| COASTGUARD | 45.22% |
| CARPHONE | 44.71% |
| CONTAINER | 74.22% |
| AKIYO | 81.92% |

Table 3 further shows that after referring to both of the spatial and temporal correlations, the probability of a current motion block accurately predicting a block size mode for encoding can be increased to over 70%.

TABLE 3

| | TEMPORAL + SPATIAL (4) |
|---|---|
| FOREMAN | 75.51% |
| COASTGUARD | 77.46% |
| CARPHONE | 77.26% |
| CONTAINER | 89.98% |
| AKIYO | 93.42% |

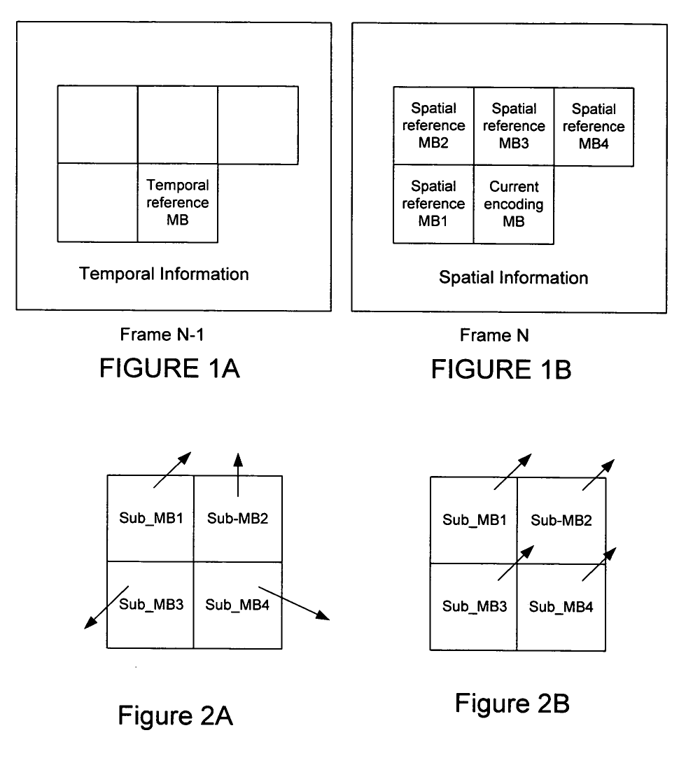

The temporal and spatial information that a current motion block refers to for obtaining predicted block size modes in accordance with an exemplary embodiment of the invention are illustrated in FIGS. 1A and 1B. FIG. 1A shows the temporal information, in which a current encoding motion block MB compares with a temporal reference motion block that is located in a previous image frame (Frame N-1) at the position corresponding to that of the current encoding motion block in a current image frame (Frame N). FIG. 1B shows the spatial information, in which the current encoding motion block MB compares with its left MB1, upper left MB2, upper MB3, and upper right MB4 neighboring motion blocks.

As described above, the conventional H.264 technique analyzes seven possible block size modes (i.e., 16×16, 16×8, 8×16, 8×8, 8×4, 4×8, and 4×4) and selects one from the seven block size modes for encoding. The present invention, on the other hand, need only analyze a subset of the seven block size modes such that the time for encoding can be reduced. As mentioned previously, this novel methodology is referred to as a fast mode decision (FMD) algorithm. The FMD algorithm can save about 49% of the encoding time. The encoding quality, however, is also reduced about 0.6 dB.

To improve the encoding quality of the above FMD algorithm, another exemplary embodiment in accordance with the present invention further analyzes the reliability of each predicted block size mode of each motion block before using the predicted block size mode for encoding. If the predicted block size mode is reliable, the motion block then uses the predicted block size mode for encoding. Otherwise, a full mode search will be performed on the whole motion block to search for a best block size mode. This method is referred to herein an enhanced fast mode decision (EFMD) algorithm.

According to the EFMD algorithm, the predicted information obtained by the FMD algorithm is used for motion estimation to obtain all possible predicted block size modes. To determine the reliability of the predicted block size modes, the EFMD algorithm considers the variance and the magnitude difference of motion vectors obtained from the motion estimation. Preferably, if more than half of the predicted block size modes are reliable, the FMD predicted information is considered being reliable and can be used for encoding.

FIGS. 2A and 2B illustrate motion blocks that have a large motion vector variance and a small motion vector variance, respectively. As shown in the figures, a 16×16 motion block is divided into four 8×8 blocks sub_MB1, sub_MB2, sub_MB3, and sub_MB4. In FIG. 2A, each of the four 8×8 blocks has a different motion vector so that the whole motion block has a large motion vector variance. On the contrary, in FIG. 2B, each of the four 8×8 blocks has a similar motion vector so that the motion vector variance of the motion block is small. In this case, the 16×16 motion block itself should be used for encoding. That is, when the motion vector variance of smaller blocks is small, a larger block encompassing the smaller blocks is more suitable for encoding. However, if the block size mode is 16×16, there is only one group of motion vectors after the motion estimation. Consequently, no motion vector variance can be calculated therefrom. Accordingly, the exemplary embodiment only considers the motion vector variance for determining the reliability when the predicted block size modes are smaller than the 16×16 block size mode.

The motion vector variances may be calculated by the following equations. In accordance with the present invention, block size modes of which the motion vector variances are larger than a variance threshold value THᵥₐᵣ are determined as reliable.

$$\begin{matrix}{MV\_VAR}_{cur} = ( {MVx\_VAR}_{cur} + {MVy\_VAR}_{cur} ) / 2 & ( 1 ) \\ {MVx\_VAR}_{cur} = \sqrt{\frac{1}{n} {\sum }_{m = 0}^{n} {( {MVx}_{cur} - {MVx}_{cur}^{m} )}^{2}} & ( 2 ) \\ {MVy\_VAR}_{cur} = \sqrt{\frac{1}{n} {\sum }_{m = 0}^{n} {( {MVy}_{cur} - {MVy}_{cur}^{m} )}^{2}} & ( 3 ) \\ {MVx}_{cur} = ( {\sum }_{m = 1}^{n} {MVx}_{cur}^{m} ) / n , {MVy}_{cur} = ( {\sum }_{m = 1}^{n} {MVy}_{cur}^{m} ) / n & ( 4 ) \\ {MVx}_{ref} = ( {\sum }_{m = 1}^{n} {MVx}_{ref}^{m} ) / n , {MVy}_{ref} = ( {\sum }_{m = 1}^{n} {MVy}_{ref}^{m} ) / n & ( 5 )\end{matrix}$$

wherein n is the number of motion vectors existed in each block, MVx and MVy are component motion vectors in the x direction and the y direction, respectively, and MV_{cur} and MV_{ref} are motion vectors of a current block and a reference block, respectively.

A statistic result that uses the motion vector variance to determine the reliability of a block size mode that is smaller than the 16×16 block size mode is shown by the following Table 4. From Table 4, the average accuracy is higher than 85%.

TABLE 4

| | P(B\|A) | P(C\|A) |
|---|---|---|
| FOREMAN | 81% | 19% |
| COASTGUARD | 84% | 16% |
| CARPHONE | 85% | 15% |
| CONTAINER | 92% | 8% |
| AKIYO | 87% | 13% |
| Average | 86% | 14% |

A: MV_VAR_{cur} > THᵥₐᵣ
B: predicted block size mode is correct
C: predicted block size mode is incorrect

As described above, only the reliabilities of the block size modes smaller than the 16×16 block size mode can be determined by the motion vector variance. For the 16×16 block size mode, the reliability is determined from its motion vector magnitude difference. It is known that if two adjacent blocks belong to a same object or have a same motion trajectory, the chance of the two adjacent blocks using a same block size mode for encoding will be very high. Accordingly, the motion vectors of the two adjacent blocks are also similar, that is, the motion vector magnitude difference of the two adjacent blocks is small. On the contrary, if the motion vectors of the two adjacent blocks are different, it can be predicted that the two adjacent blocks have different motion trajectories, that is, do not use a same block size mode for encoding. Based on this concept, if the motion vector magnitude difference of a current block from its adjacent block is smaller than a magnitude difference threshold value TH_{mag}, the current block is then considered as reliable. The magnitude difference Mag_dif_{cur} is determined by the following equation.
Mag_{—}dif_{cur}=|MVx_{cur}−MVx_{ref}|+|MVy_{cur}−MVy_{ref}| (6)

The following Table 5 shows the reliability statistic result by calculating the motion vector magnitude difference. From Table 5, it can be seen that the average accuracy is higher than 80%.

TABLE 5

| | P(B\|A) | P(C\|A) |
|---|---|---|
| FOREMAN | 75% | 25% |
| COASTGUARD | 70% | 30% |
| CARPHONE | 78% | 22% |
| CONTAINER | 93% | 7% |
| AKIYO | 94% | 6% |
| Average | 82% | 18% |

A: Mag_dif_{cur} < TH_{mag}
B: the predicted block size mode is correct
C: the predicted block size mode is incorrect

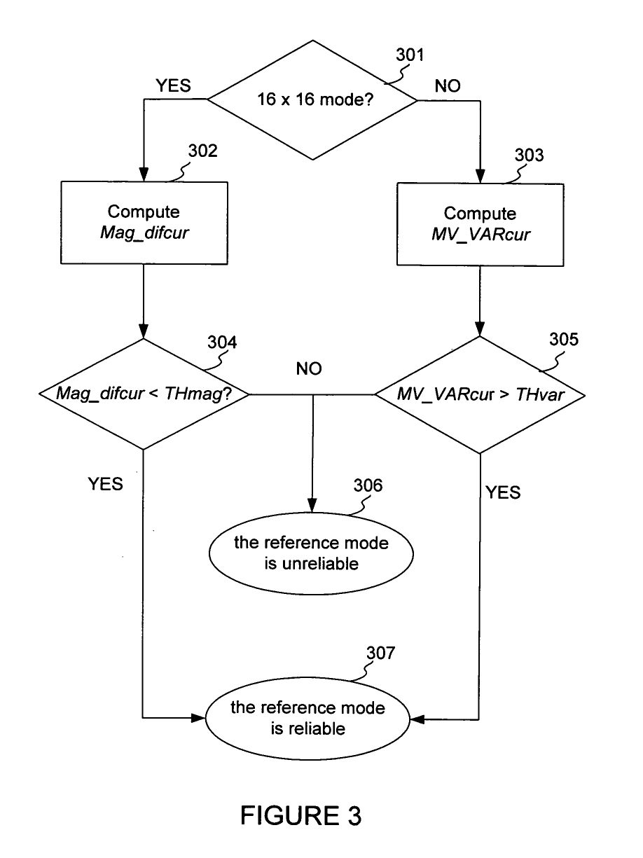

The process for determining the reliabilities by the motion vector variance and motion vector magnitude difference is illustrated in FIG. 3. As shown at step 301, the process first determines whether the predicted block size mode (hereinafter called “reference block size mode”) is a 16×16 block size mode. If so, the process goes to step 302, that is, the reliability of the reference block size mode is determined by its motion vector magnitude difference. If not, i.e., the reference block size mode is smaller than 16×16, the process goes to step 303, that is, the reliability of the predicted block size mode is determined by its motion vector variance.

At step 302, the process calculates the motion magnitude difference (Mag_dif_{cur}) of the reference block size mode according to equation (6) mentioned above. At step 304, the motion magnitude difference Mag_dif_{cur} is then compared with the magnitude difference threshold value TH_{mag}. As shown at step 306, if Mag_dif_{cur} is larger than TH_{mag}, the reference block size mode is considered as “unreliable”. Otherwise, the reference block size mode is considered as “reliable”, as shown at step 307.

At step 303, as the reference block size mode is not a 16×16 block size mode, i.e., a smaller block size mode, the process calculates the motion vector variance MV_VAR_{cur} according the equations (1)-(5) described above. At step 305, the motion vector variance MV_VAR_{cur} is then compared with a variance threshold value THᵥₐᵣ. As mentioned above, if the motion vector variance MV_VAR_{cur} is smaller than the threshold value THᵥₐᵣ, the reference block size mode is considered as “unreliable”, as shown at step 306. Otherwise, the reference block size mode is considered as “reliable”, as shown at step 307.

As described above with reference to FIGS. 2A and 2B, to decide a best block size mode for a current encoding block, an exemplary embodiment of the present invention refers to the reference blocks surrounding the current encoding block to obtain predicted information. By analyzing the predicted information, a plurality of block size modes are obtained. Generally, if the prediction information for some reference blocks are the same, the block size modes used for these reference blocks are also the same. Furthermore, if more than half of the reference blocks use a same block size mode, the chances that the current encoding block will use the same block size mode for encoding is very high. This assumption is proved by the experimental results shown in the following Table 6.

TABLE 6

| | P(B\|A) | P(C\|A) |
|---|---|---|
| FOREMAN | 66% | 34% |
| COASTGUARD | 62% | 38% |
| CARPHONE | 70% | 30% |
| CONTAINER | 93% | 7% |
| AKIYO | 93% | 7% |
| Average | 77% | 23% |

A: more than half of the predicted information is the same
B: use the majority of the predicted information to encode the current block
C: do not use the majority of the predicted information to encode the current block.

As indicated in Table 6, the average probability that the current block uses the majority of the prediction information from its surrounding reference blocks is up to 77%. Accordingly, in accordance with an exemplary method of the present invention, if more than half of the reference blocks use a majority block size mode, the method then determines whether this majority block size mode is reliable. If the majority block size mode is reliable, the method then uses the majority block size mode to encode the current block. If the majority block size mode is unreliable, however, the method then has to perform a full-mode search on the current motion block to select a best block size mode.

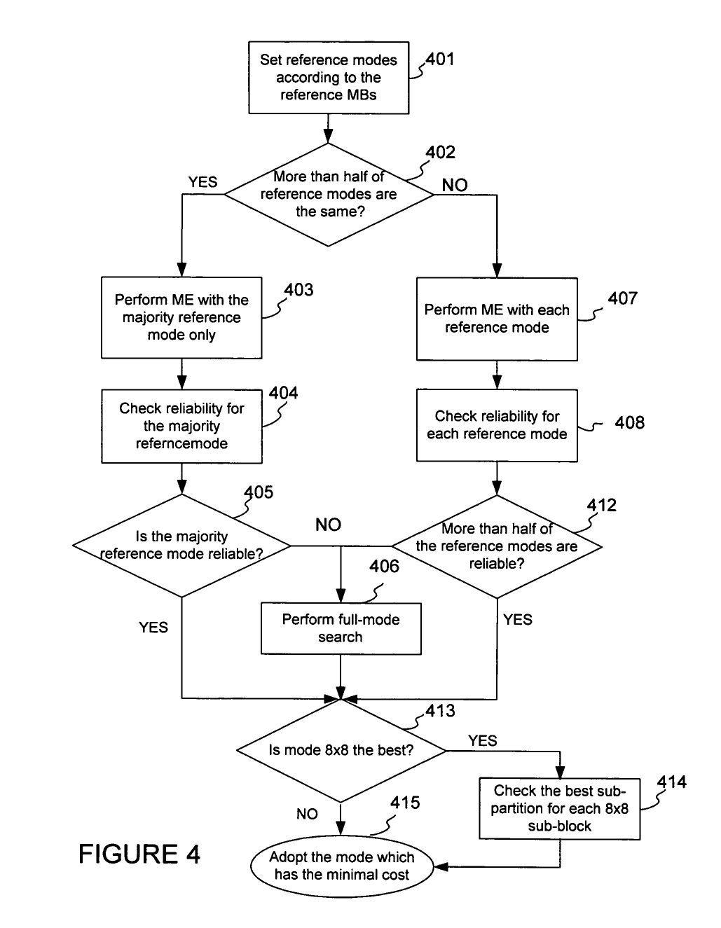

The details of determining the reliability for reference block size modes in accordance with the exemplary method of the present invention are further illustrated in FIG. 4.

At step 401, the process obtains reference block size modes according to the predicted information from the reference motion blocks.

At step 402, the process determines whether more than half of the reference block size modes are the same (i.e., the majority reference block size mode.) If so, the process goes to step 403. Otherwise, the process goes to step 407.

At step 403, the process performs a motion estimation for the majority reference block size mode, and at step 404, the process checks the reliability of the majority reference block size mode. Preferably, the reliability is determined according to the process described with reference to FIG. 3.

At step 405, if the majority reference block size mode is reliable, the process goes to step 413. Otherwise, as shown at step 406, the process performs a full-mode search on the current motion block to find out a best reference block size mode.

Furthermore, at step 407, when not more than half of the reference block size modes are the same, i.e., not more than half of the reference motion blocks adopt the same block size mode, the process performs the motion estimation for all of the reference block size modes. All of the reference block size modes are then checked, at step 408, for their reliabilities. As described above, the reliabilities are preferably determined according to the process of FIG. 3.

At step 412, the process then checks whether more than half of the reference block size modes are reliable. If not, the process then performs a full-mode search on the current motion block to find out a best block size mode, as shown at step 406. Otherwise, the process goes to step 413.

At step 413, the process checks whether a best reference block size mode obtained from steps 403-412 is an 8×8 block size mode. If so, the process goes on checking a best sub-partition for each 8×8 block, as shown at step 414. As each 8×8 block can be further divided into 8×4, 4×8, and 4×4 sub-blocks, an advantage for performing step 413 is that when the 8×8 block is not the best mode, there is no need to analyze the sub-blocks smaller than the 8×8 sub-blocks because the chance that the smaller sub-blocks are the best mode is very small. As such, the encoding time can be greatly reduced.

Finally, at step 415, if an 8×8 block size mode is not the best, the process then adopts a mode that has the minimum cost for encoding the current motion block.

The above methods for fast mode decision of variable block size coding of the present invention can greatly save time required for encoding a motion block without sacrificing significant encoding quality. The following Tables 7 and 8 are experimental data showing results of using the fast mode decision (FMD) algorithm of the present invention (i.e., without checking the reliability) and a full-block search algorithm used in the conventional methods, such as JM7.3 encoders, to encode video images. The experimental results show that the FMD algorithm of the present invention reduces about 0.12 dB of encoding quality but increases 5.71% bit rate and save about 49% of encoding time. Under the same bit rate, however, the FMD algorithm reduces 0.6 dB of encoding quality but still save about 49% of encoding time.

TABLE 7

| | PSNR | Bit rate |
|---|---|---|
| QP = 28 | difference | difference |
| FOREMAN | −0.10 dB | 4.12% |
| COASTGUARD | −0.03 dB | 2.47% |
| CARPHONE | −0.24 dB | 5.21% |
| CONTAINER | −0.10 dB | 8.20% |
| AKIYO | −0.12 dB | 8.58% |
| Average | −0.12 dB | 5.71% |

TABLE 8

| QP = 28 | Original | FMD |
|---|---|---|
| FOREMAN | 47.3 sec | 29.18 sec |
| COASTGUARD | 56.3 sec | 30.73 sec |
| CARPHONE | 42.01 sec | 20.71 sec |
| CONTAINER | 40.63 sec | 17.30 sec |
| AKIYO | 34.68 sec | 16.19 sec |
| Average | 44.18 sec | 22.82 sec |

The enhanced FMD (EFMD) algorithm of the present invention (i.e., with reliability check) has shown better results than the FMD algorithm, as shown in Tables 9 and 10. The experimental results of Tables 9 and 10 show that using the EFMD algorithm to encode the video images only reduces 0.2 dB of encoding quality but saves about 44.3% of encoding time.

TABLE 9

| | PSNR | Bit rate |
|---|---|---|
| QP = 28 | difference | difference |
| FOREMAN | −0.09 dB | 1.16% |
| COASTGUARD | −0.04 dB | 1.81% |
| CARPHONE | −0.13 dB | 1.38% |
| CONTAINER | −0.04 dB | 2.98% |
| AKIYO | −0.04 dB | 1.42% |
| Average | −0.068 dB | 1.75% |

TABLE 10

| QP = 28 | Original | EFMD |
|---|---|---|
| FOREMAN | 47.3 sec | 30.74 sec |
| COASTGUARD | 56.3 sec | 31.41 sec |
| CARPHONE | 42.01 sec | 25.12 sec |
| CONTAINER | 40.63 sec | 19.13 sec |
| AKIYO | 34.68 sec | 17.72 sec |
| Average | 44.18 sec | 24.82 sec |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for fast mode decision of variable block size coding, comprising:
obtaining at least one reference block size mode from at least one reference motion block;
performing a motion estimation for the at least one reference block size mode; and
determining a best block size mode from the at least one reference block size mode based on the motion estimation results for use in encoding a current motion block.

2. The method of claim 1, wherein the at least one reference motion block includes at least one neighboring motion block of the current motion block.

3. The method of claim 1, wherein the at least one reference motion block includes a previous motion block that is located in a previous image frame at a position corresponding to that of the current encoding motion block in a current image frame.

4. The method of claim 2, wherein the at least one neighboring motion block includes at least one of motion blocks located at left, upper left, upper, and upper right of the current motion block.

5. The method of claim 1, further comprising checking reliability of the reference block size mode.

6. The method of claim 5, wherein the checking the reliability includes:
performing a motion estimation for the current motion block and the at least one reference motion block to obtain motion vectors for the current motion block and the reference motion blocks;
if the at least one reference block size mode is a largest block size mode, comparing and calculating a motion vector magnitude difference of the current motion block from the at least one reference motion block that adopts the at least one reference block size mode; and
if the motion vector magnitude difference is less than a first threshold value, deciding that the at least one reference block size mode is reliable.

7. The method of claim 6, further comprising:
if the at least one reference block size mode is not the largest block size mode, comparing and calculating a motion vector variance of the current motion block; and
if the motion vector variance is larger than a second threshold value, deciding that the at least one reference block size mode is reliable.

8. A method for fast mode decision of variable block size coding, comprising:
obtaining a plurality of reference modes according to a plurality of reference motion blocks;
performing a motion estimation for each of the plurality of reference modes; and
determining whether each of the reference block size modes is reliable according to the motion estimation result.

9. The method of claim 8, further comprising:
determining whether a reference mode of a reference motion block has a largest size of block; and
if the reference mode has a largest size of block,
determining whether a motion vector magnitude difference of the reference motion block from a current motion block is less than a first threshold; and
deciding that the reference mode is reliable if the motion vector magnitude difference is less than the first threshold.

10. The method of claim 8, further comprising, if the reference mode does not have a largest size of block:
calculating a motion vector variant of the current motion block;
determining whether the motion vector variant of the current motion block is larger than a second threshold; and
deciding that the reference mode is reliable if the motion vector variant is larger than the second threshold.

11. A method for fast mode decision of variable block size coding, comprising:
obtaining a plurality of reference modes according to a plurality of reference motion blocks;
determining that more than half of the plurality of the reference motion blocks adopt a first reference mode;
performing a reliability check for the first reference mode; and
if the first reference mode is reliable, using the first reference mode to encode a current motion block.

12. The method of claim 11, wherein the plurality of reference motion blocks includes at least one of neighboring motion blocks of the current motion block and a previous motion block that is located in a previous image frame at a position corresponding to that of the current motion block in a current image.

13. The method of claim 11, further comprising, if the first reference mode is not reliable, performing a full-mode search on the current motion block to find a best mode.

14. The method of claim 11, further comprising:
determining that not more than half of the plurality of the reference motion blocks adopt a same first reference mode;
performing a motion estimation for all the reference mode of the plurality of the reference motion blocks;
checking whether the reference modes are reliable;
determining whether more than half of the reference modes are reliable; and
choosing one reliable reference mode that has a minimal cost to encode the current motion block.

15. The method of claim 14, further comprising, if not more than half of the reference modes are reliable, performing a full-mode search on the current motion block to find a best mode.

16. The method of claim 11, further comprising, if the first reference block mode is a smallest block size mode, checking whether the block size mode can be further divided into smaller sub-block modes, and choosing one sub-block mode that has the minimal cost for encoding the current motion block.

17. The method of claim 14, further comprising determining if the smallest block size mode is most suitable among the reliable reference modes, and if so, checking whether the smallest block size mode can be further divided into smaller sub-block modes, and choosing one sub-block mode that has the minimal cost for encoding the current motion block.

18. The method of claim 11, wherein determining whether the first reference mode is reliable comprises:
determining whether the first reference mode is a largest block size mode; and
if the first reference mode is the largest block size mode,
determine a motion vector magnitude difference of the reference motion blocks adopting the first reference mode from the current block mode;
deciding that the reference mode is reliable if the motion vector magnitude difference is less than a first threshold;
if the first reference mode is not the largest block size mode,
determine a motion vector variance of the current motion block; and
deciding that the reference mode is reliable if the motion vector variance is higher than a second threshold.
